(19) United States
(12) Patent Application Publication
(10) Pub. No.: US 2010/0000967 A1
(43) Pub. Date: Jan. 7, 2010

(54) REMOVAL METHOD OF SURFACE DAMAGE OF SINGLE CRYSTAL DIAMOND

(75) Inventors: Yoshiaki Mokuno, Osaka (JP); Akiyoshi Chayahara, Osaka (JP); Hideaki Yamada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL INSTITUTE OF ADVANCED INDUSTRIAL SCIENCE AND TECHNOLOGY, Tokyo (JP)

(21) Appl. No.: 12/336,841

(22) Filed: Dec. 17, 2008

(30) Foreign Application Priority Data
Jul. 4, 2008 (JP) 2008-175183

(51) Int. Cl. B44C 1/22

(52) U.S. Cl. 216/28

(57) ABSTRACT

The present invention provides a process for removing surface damage of a single-crystal diamond, which comprises implanting ions into a single-crystal diamond to form a non-diamond layer near a surface of the diamond, graphitizing the non-diamond layer, and removing a surface layer by etching. According to the invention, the surface damage can be removed or reduced without increasing the surface roughness of a single crystal diamond.

### TECHNICAL FIELD

The present invention relates to a surface treatment method for removing or reducing the surface damage of a single-crystal diamond, which is typically used as substrates for electronic devices.

### BACKGROUND ART

Single-crystal diamond, by virtue of its outstanding semiconductor properties, is expected to be in practical use as a material for electronic devices, such as power devices. In the preparation of such devices, high-quality large single-crystal substrates are required, as with other semiconductor materials.

In the high-temperature high-pressure synthesis method known as the primary synthesis method, the substrate size is considered as limited to about 10×10 mm. In recent years, however, owing to the rapid progression of the single-crystal diamond synthesis technique using a chemical vapor deposition (CVD) method, the synthesis of 10×10 mm substrates, which are equal in size to those synthesized by high-temperature high-pressure synthesis, has been realized; there is also the possibility that the substrate size can, in principle, be further increased.

In regard to quality, a substrate requires, in addition to the crystallinity of the bulk of the substrate itself, surface flatness and less surface damage caused by cutting, polishing, etc. This is because, during the device fabrication process, a conductivity-controlled single-crystal film is, in general, grown by epitaxial growth on a substrate; any defects present inside the substrate or on the substrate surface are continued in an epitaxial growth film grown thereon, causing degradation of the crystal quality of these films. Therefore, reduction or control of the defects inside a substrate, planarization of the substrate surface, and reduction or removal of the surface damage have been the issues for improving the substrate quality; thus, solutions therefor have been suggested from various viewpoints.

From the viewpoint of defect control, it has been shown that, by utilizing the feature of a CVD synthetic single-crystal diamond that any dislocations generally propagate toward the growth direction, substrates having substantially defect-free surfaces can be produced by cutting a CVD diamond so that, when cutting the diamond into a substrate (plate), the original growth direction is included within the substrate (see Patent Document 1 below). The obtained substrates (plates), however, contain a certain amount of surface damage introduced by cutting and polishing, but no method for reducing or removing this damage has been disclosed.

In regard to the planarization of a substrate surface, a certain degree of planarization (a surface roughness Ra of 10 nm or less) can be achieved by carefully conducting mechanical polishing. As a method for obtaining an even flatter surface, a surface planarization method has been suggested in which a non-diamond layer is formed within a depth of asperities in a diamond surface layer by implanting ions from an oblique direction; the non-diamond layer is then subsequently removed by electrochemical etching (see Patent Document 2 below). Even with these methods, however, it is usually difficult to remove processing damage introduced beyond the depth of asperities.

From the viewpoint of reducing or removing the surface damage, a method in which a substrate surface is etched by reactive ion etching has been disclosed (see Patent Document 3 below). If the surface damage is deep, however, increasing the etching depth not only requires a prolonged period of etching time, but also poses the possibility of increasing the surface roughness due to etching, which, in the subsequent single-crystal growth, causes degradation of the crystallinity due to the surface roughness. In some cases, etching is performed in a CVD apparatus using a plasma created in a gaseous mixture containing hydrogen, a small amount of oxygen gas or the like (see Patent Document 4 below). This method, particularly when performed in the apparatus just before moving onto the diamond growth, is also described as effective for removing surface contamination. However, a substrate after etching has thereon many depressions, termed etch pits, which become the starting points of non-epitaxial crystallites in the subsequent growth of a single-crystal diamond, causing new dislocations from the interface between the substrate and the growth layer.

As described above, although the issues presented in improving the quality of single-crystal diamond substrates are individually being resolved, a method capable of solving all of these problems simultaneously has yet been established.

### PRIOR ART DOCUMENTS

### Patent Documents

Patent Document 1: Japanese Unexamined Patent Publication No. 2006-508881
Patent Document 2: Japanese Unexamined Patent Publication No. 2001-509839
Patent Document 3: Japanese Unexamined Patent Publication No. 2005-225746
Patent Document 4: Japanese Unexamined Patent Publication No. 2004-503460

### DISCLOSURE OF THE INVENTION

### Problem to be Solved by the Invention

The invention was made in view of the above-described state of the prior art. A principal object of the invention is to provide a novel process that is effective for removing or reducing the surface damage of a single-crystal diamond, without increasing the surface roughness thereof.

### Means for Solving the Problem

The present inventors conducted extensive research in order to achieve this object. Consequently, the inventors found that it is possible to remove the damage present at a surface portion of a single-crystal diamond caused by polishing, cutting, etc., without increasing the surface roughness thereof, by forming a non-diamond layer in a single-crystal diamond by ion implantation, and subsequently graphitizing the non-diamond layer by high-temperature annealing or a like method; and removing the graphitized layer together with a surface layer by etching. This finding led to the completion of the invention.

More specifically, the invention provides a process, as summarized below, for removing the surface damage of a single-crystal diamond.
1. A process for removing surface damage of a single-crystal diamond, comprising implanting ions into a single-crystal diamond to form a non-diamond layer near a surface of the diamond, graphitizing the non-diamond layer, and removing a surface layer by etching.
2. A process for removing surface damage of a single-crystal diamond, comprising repeating, at least two times, the process of Item 1 comprising implanting ions into a single-crystal diamond to form a non-diamond layer near a surface of the diamond, graphitizing the non-diamond layer, and removing a surface layer by etching.
3. The process according to Item 1, wherein the single-crystal diamond to be processed is a single-crystal diamond synthesized by a CVD method, the single-crystal diamond having a surface substantially in parallel with a direction of propagation of dislocations in the diamond.
4. The process according to Item 2, wherein the single-crystal diamond to be processed is a single-crystal diamond synthesized by a CVD method, the single-crystal diamond having a surface substantially in parallel with a direction of propagation of dislocations in the diamond.
5. A process for producing a single-crystal diamond, comprising removing surface damage of a single-crystal diamond according to the process of Item 1; and growing a single-crystal diamond by a CVD method on a substrate of the single-crystal diamond from which the surface damage has been removed.
6. A process for producing a single crystal diamond, comprising removing surface damage of a single-crystal diamond according to the process of Item 2; and growing a single-crystal diamond by a CVD method on a substrate of the single-crystal diamond from which the surface damage has been removed.

In the process of the invention for removing surface damage of a single-crystal diamond, a non-diamond layer is formed near a surface of a single-crystal diamond by an ion-implantation method, and the resulting non-diamond layer is graphitized, after which a surface portion is removed by etching. In this way, damage present at a surface side of the diamond above the non-diamond layer can be removed. By repeating this process, as required, the surface damage layer of a single-crystal diamond can be substantially completely removed.

The process of the invention for removing surface damage of a single-crystal diamond is described in detail below.

### Object to be Processed

The object to be processed by the process of the invention is a single-crystal diamond having a damaged portion in a surface layer, i.e., at the surface of the diamond or inside thereof near the surface.

The damage in the surface layer of a single-crystal diamond to be removed by the process of the invention includes disorders in the crystal structure, cracks, and the like that are present near the surface of the diamond. Typically, this damage develops near the surface of a single-crystal diamond when cutting out the single-crystal diamond to a necessary size, or when mechanically polishing the surface of the single-crystal diamond by scaife polishing or a like method. The thickness of this damaged portion varies depending on the cutting or polishing conditions; typically, however, the damaged portion is present in a depth of up to about 10 μm from the surface.

The above-described damage present in the surface layer of a single-crystal diamond, when growing a single-crystal diamond film by epitaxial growth on this single-crystal diamond as a substrate, is continued as crystal defects to the epitaxial growth film grown thereon, causing degradation of the crystal quality of these films.

The type of the single-crystal diamond to be processed is not limited; any insulating single-crystal diamond, such as a natural diamond, a synthetic diamond, etc., can be used as the diamond to be processed. The method for producing a synthetic diamond is not also limited; various single-crystal diamonds obtained by known methods such as, for example, a high-temperature high-pressure synthesis method, a CVD method, etc., can be used as the diamond to be processed.

The crystal plane of the surface of the single-crystal diamond to be processed is not also limited. Any single-crystal diamond having a surface of a desired crystal plane, such as, for example, (100), (111), (110), or a like plane, can be used as the diamond to be processed. Moreover, the surface of the single-crystal diamond may have a desired off-angle with respect to a specific crystal plane.

### Formation of a Non-Diamond Layer in a Single-Crystal Diamond

In the process of the invention, ions are first implanted into a single-crystal diamond to be processed, to form a non-diamond layer near a surface of the diamond. In this step, by implanting ions into the diamond from one surface thereof, a non-diamond layer having a deteriorated crystal structure is formed near the surface of the diamond.

FIG. 1 is a schematic flowchart showing the process for removing surface damage layer according to the invention; wherein FIG. 1(a) schematically shows the state in which an ion-implanted layer is formed.

The ion implantation method is a method of irradiating a sample with swift ions. In general, ion implantation is performed as follows: a desired element is ionized, and the resulting ions are accelerated in an electric field created by application of a voltage, after which the ions are mass-separated, and ions with a desired level of energy are directed to the sample. Alternatively, it may be performed by a plasma-ion implantation method, in which the sample is immersed in plasma, and negative high-voltage pulses are applied to the sample to attract positive ions in the plasma to the sample. Examples of implanted ions include carbon, oxygen, argon, helium, protons, and the like.

The ion implantation energy may be in the range of from about 10 keV to about 10 MeV, which is typically used in ion implantation. Implanted ions are distributed mainly at a depth of implantation (projectile range), with a certain width of depth; the depth of implantation is determined according to the type and energy of the ions, as well as the type of the sample. Damage to the sample is maximized in the vicinity of the projectile range where ions stop, but the surface side of the substrate above the vicinity of the projectile range also experiences a certain degree of damage caused by the passage of ions. The projectile range and the degree of damage can be calculated and predicted using a Monte Carlo simulation code, such as the SRIM code.

By implanting ions into the substrate, when the dose exceeds a certain level, the crystal structure at the surface side of the substrate above the vicinity of the projectile range undergoes deterioration, causing the destruction of the diamond structure, thereby facilitating the separation of the surface portion above the deteriorated portion.

The depth of the deteriorated portion to be formed may be determined according to the predicted depth of the surface damage. More specifically, the projectile range may be selected so as to form a non-diamond layer at a position deeper than the damaged portion. When the damaged portion extends deep below the surface, the following method may be employed. A non-diamond layer is formed midway in the damaged portion, and a surface portion is subsequently removed by etching according to the method described below. Subsequently, the formation and graphitization of a non-diamond layer, as well as the removal of a surface portion, are repeated, the number of times required. In this way, the damaged portion can be removed substantially completely. The latter method is not only effective when the energy of the usable ions is limited, but also has an advantage in that the thickness of the surface layer to be removed can be minimized by evaluating the presence or absence of surface damage by utilizing polarized light microscope images, X-ray diffraction, or the like, each time the surface layer is removed.

The thickness and the degree of deterioration of the deteriorated portion vary depending on the type of ion used, the ion implantation energy, the dose, and the like. These conditions may therefore be determined so that a deteriorated layer that can be separated is formed near the projectile range. More specifically, in a region with the highest atomic density of implanted ions, the atomic density is preferably about 1×10²⁰ atoms/cm³ or more. In order to ensure the formation of a non-diamond layer, the atomic density is preferably about 1×10²¹ atoms/cm³ or more, i.e., a displacement damage of 1 dpa or more.

For example, in order to remove a surface layer with a depth of 1.6 μm from the surface, carbon ions may be implanted at an energy level of 3 MeV, and the ion dose may be about 1×10¹⁶ ions/cm² or more. In this case, if the dose is too small, a non-diamond layer is not sufficiently formed, making the separation of the damage layer difficult.

Next, after the ion implantation, the diamond is heat-treated at a temperature of 600° C. or higher in a non-oxidizing atmosphere, such as a vacuum, a reducing atmosphere, an oxygen-free inert gas atmosphere, or the like, thereby allowing the graphitization of the non-diamond layer to proceed. This causes etching in the subsequent step to proceed rapidly. The upper limit for the heat-treatment temperature is the temperature at which the diamond begins to graphitize, which is typically about 1,500° C. The heat-treatment time varies depending on the treatment conditions, such as the heat-treatment temperature and the like; for example, it may be from about 5 minutes to about 10 hours.

The heat treatment can also be performed by, for example, using a vapor deposition apparatus for diamond growth. In this case, heat treatment may be performed under the above-described conditions in, for example, a hydrogen-gas atmosphere generally employed in diamond synthesis.

### Etching of the Non-Diamond Layer

After the formation of the non-diamond layer in the single-crystal diamond by ion implantation according to the above-described method, followed by graphitization of the non-diamond layer, the non-diamond layer is etched, as shown in FIG. 1(b), causing the removal of a surface layer containing surface damage above the portion of the non-diamond layer.

The method for removing the surface layer is not limited; for example, electrochemical etching, thermal oxidation, electric discharge machining, etc., can be applied.

As a method for removing the non-diamond layer by electrochemical etching, the following method, for example, can be employed. Two electrodes are disposed in an electrolytic solution at a certain interval. Subsequently, the single-crystal diamond containing the non-diamond layer is placed between the electrodes in the electrolytic solution, and a direct-current (DC) voltage is applied across the electrodes. Pure water is preferable as the electrolyte. While the electrode material may be any conductive material, chemically stable electrodes, such as platinum, graphite, or the like, are preferable. The electrode interval and the applied voltage may be adjusted to allow the etching to proceed most rapidly. The electric field strength in the electrolytic solution may typically be from about 100 to about 300 V/cm.

Among methods for removing the non-diamond layer by electrochemical etching, when the method of etching by the application of an alternating-current (AC) voltage is used, etching proceeds into the non-diamond layer of a crystal extremely rapidly, even in a large single-crystal diamond, thereby enabling the separation of the diamond at the surface side thereof above the non-diamond layer in a short period of time.

In the method using the application of an AC voltage, the electrode interval and the applied voltage may also be adjusted so that the etching proceeds most rapidly. Typically, the electric field strength in the electrolytic solution, determined by dividing the applied voltage by the electrode interval, is preferably from about 50 to about 10,000 v/cm, and more preferably from about 500 to about 10,000 V/cm.

While a commercial sinusoidal alternating current with a frequency of 60 or 50 Hz is readily available as an alternating current, the waveform is not limited to a sinusoidal waveform, as long as the current has a similar frequency component.

Pure water used as an electrolytic solution advantageously has a higher resistivity (i.e., a lower conductivity) to allow the application of a higher voltage. Ultrapure water produced using a general ultrapure water-producing apparatus has a sufficiently high resistivity, about 18 MΩ·cm, and is thus suitable for use as an electrolytic solution.

As a method for removing the non-diamond layer by thermal oxidation, the following method, for example, may be performed. A substrate is heated to a high temperature of about 500 to about 900° C. in an oxygen atmosphere, to etch the non-diamond layer by oxidation. At this time, as the etching proceeds into the substrate, the passage of oxygen from the outer periphery of the crystal becomes difficult. Thus, when the oxygen ion is selected as the ion to form a non-diamond layer, and a large amount of oxygen ions, which sufficiently exceed the dose necessary to cause etching, are implanted beforehand, oxygen can also be supplied from the inside of the non-diamond layer during etching, allowing the etching of the non-diamond layer to proceed more rapidly.

Because a graphitized non-diamond layer is conductive, it can also be cut (etched) by electric discharge machining.

By forming and graphitizing a non-diamond layer, followed by etching the resulting non-diamond layer according to the above-described process, it is possible to remove the damaged portion at the surface side of the crystal above the non-diamond layer. In this case, as shown in FIGS. 1(c) and (d), by repeating the above-described process, as required, to remove the surface damage portion until the sum of the projectile ranges (the depths of the implanted ions) coincides with or exceeds the depth of the surface damage layer of the single-crystal diamond, it is possible to remove the surface damage layer of the single-crystal diamond substantially completely.

### PREFERRED EMBODIMENTS OF THE INVENTION

In the invention, particularly preferable for use as the single-crystal diamond to be processed is a single-crystal diamond that is synthesized by a CVD method, and has a surface substantially in parallel with the direction of propagation of dislocations in the grown single-crystal diamond.

It is known that single-crystal diamonds synthesized by homoepitaxial growth using a CVD method contain dislocations (bundles) in parallel with the growth direction. These dislocations are attributed to defects in the single-crystal diamond substrate used to synthesize a CVD diamond, defects present at the substrate surface, etc. More specifically, during the formation of a single-crystal diamond by a CVD method, such defects are replicated in the grown single-crystal diamond to develop dislocations. These dislocations propagate in a single-crystal diamond formed by a CVD method in a direction substantially vertical to the surface of a substrate. Therefore, even if the surface damage of the single-crystal diamond obtained by this method is directly removed according to the above-described method, the number of the dislocations arising at the surface of the single-crystal diamond cannot be reduced.

In the invention, it is preferable to cut the single-crystal diamond formed by a CVD method to separate a portion of the single-crystal diamond so that the surface thereof is formed in a direction substantially parallel with the direction of propagation of dislocations; and remove the surface damage of the separated single-crystal diamond, which is used as the diamond to be processed, according to the above-described method. The single-crystal diamond separated by this method is free of any dislocations arising at the surface, or has very few dislocations that intersect the surface, because the linear dislocation pattern that indicates the propagation of dislocations is present substantially in parallel with the surface of the diamond. For this reason, by removing the surface damage layer of this single-crystal diamond according to the above-described method, it is possible to produce a satisfactory single-crystal diamond substantially free of surface defects.

A single-crystal diamond having a surface substantially in parallel with the direction of propagation of dislocations can be obtained, for example, according to the process disclosed in the above-listed Patent Document 1 (Japanese Unexamined Patent Publication No. 2005-508881).

As shown in FIG. 2(a), in the homoepitaxial growth of a diamond that begins from the surface of a diamond substrate, any dislocations or defects present at the substrate surface propagate substantially vertically to the substrate surface. The grown single-crystal diamond that contains such dislocations is cut out substantially vertically to the substrate surface, as indicated by the dashed line in FIG. 2(a).

As shown in FIG. 2(b), although the separated single-crystal diamond contains a damaged layer caused by cutting at the surface portion, the direction of propagation of dislocations is substantially in parallel with the surface of the single-crystal diamond. Therefore, the single-crystal diamond is substantially free of dislocations that intersect the surface thereof, or has very few dislocations.

In this case, the surface of the separated single-crystal diamond need not be completely vertical to the substrate surface; the diamond may be cut so as to minimize the dislocations arising at the surface, according to the dislocation pattern present in linear form in the single-crystal diamond growth layer.

In the single-crystal diamond separated as above, a damaged portion has been formed in the surface layer during cutting. If a diamond is grown by a CVD method using this single-crystal diamond as a substrate without any processing, many new dislocations develop from the interface between the substrate and growth layer.

According to the method of the invention, the surface damage layer of a single-crystal diamond can be substantially completely removed by subjecting a single-crystal diamond that has been separated so that the surface thereof is formed in a direction substantially parallel with the direction of propagation of dislocations to the following procedure: forming a non-diamond layer by ion implantation and graphitizing the layer, as shown in FIG. 2(c); removing the surface portion by etching the non-diamond layer, as shown in FIG. 2(d); and repeating this procedure, as required.

The resulting single-crystal diamond is substantially completely free of surface defects caused by cutting, polishing, etc., and has very few dislocations that intersect the surface thereof. Accordingly, by growing a diamond by a CVD method on the thus-processed single-crystal diamond as a substrate, it is possible to remarkably prevent the propagation of dislocations or the formation of new dislocations, thereby significantly improving the crystallinity of the resulting single-crystal diamond.

### EFFECTS OF THE INVENTION

According to the process of the invention, it is possible to substantially completely remove defects present in the surface layer of a single-crystal diamond.

In particular, when the substrate to be processed is a single-crystal diamond synthesized by a CVD method, in which the linear dislocation pattern that indicates the propagation of dislocations runs in parallel with the substrate surface, it is possible, by removing any damage according to the above-described process, to produce a satisfactory single-crystal diamond that is substantially completely free of surface damage and dislocations that intersect the surface. By using such a single-crystal diamond as a substrate to grow a diamond by a CVD method, the crystallinity of the resulting single-crystal diamond can be significantly improved.

### BRIEF DESCRIPTION OF THE DRAWINGS

FIG. 1 is a schematic flowchart showing the process for removing surface damage layer according to the invention; and

FIG. 2 is a schematic flowchart showing an embodiment of the invention.

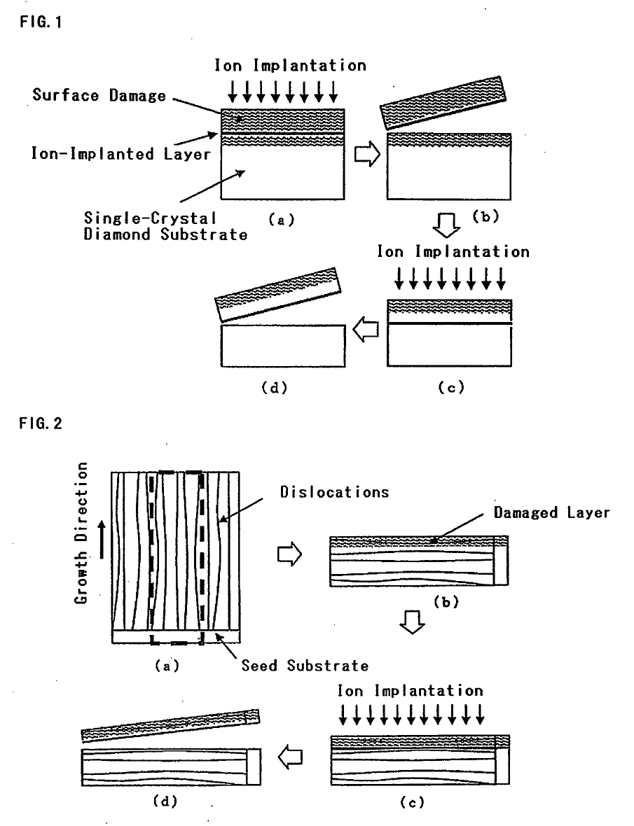

### MODES FOR CARRYING OUT THE INVENTION

The invention will be described in greater detail below, with reference to the Examples.

### EXAMPLE 1

An Ib single-crystal diamond (100) substrate, synthesized by a high-temperature high-pressure synthesis method, and mechanically polished to a size of 9.3×9.5×1.05 mm³, was used as a substrate to be processed, and the removal of surface damage was performed according to the following process.

First, carbon ions were implanted into the single-crystal diamond substrate at an energy level of 3 MeV and a dose of 2×10¹⁶ ions/cm², using a 1.5 MV tandem accelerator. The calculated value of the depth of implanted ions was about 1.6 μm. This irradiation caused the color of the diamond substrate to change from pale yellow to black, thus confirming the formation of a non-diamond layer.

Next, the single-crystal diamond substrate was heat-treated using a commercial microwave plasma CVD apparatus, causing the graphitization of the non-diamond layer to proceed. The heat treatment was performed for 25 minutes at a substrate temperature of 1,130° C., a pressure of 24 kPa, and a hydrogen-gas flow rate of 500 sccm. After the heat treatment, the growth of a single-crystal diamond film was performed for several hours, with the introduction of 60 sccm of methane gas and 0.6 sccm of nitrogen gas. This diamond film was used to remove the surface layer of the single-crystal diamond substrate to be processed, and evaluate the degree of damage of the surface layer based on the crystallinity of the film epitaxially grown on the substrate.

Two separate platinum electrodes were disposed at an interval of about 1 cm in a beaker containing pure water, and the substrate on which the single-crystal diamond film was grown by the above-described method was placed between the electrodes. An AC voltage with an effective value of 5.6 kV and a frequency of 60 Hz was applied between the electrodes, and the substrate was allowed to stand for 15 hours; as a result, the graphitized black non-diamond layer had disappeared when visually observed. Because of the possibility that the non-diamond layer that could not be visually observed still remained, the application of an AC current was continued for another 24 hours under the same conditions. As a result, the surface layer containing a damage layer was removed from the single-crystal diamond substrate, together with the single-crystal diamond film formed on the substrate by a CVD method.

The single-crystal diamond substrate from which the surface layer had been removed by the above-described process was again subjected to the implantation of carbon ions and heat treatment, growth of a single-crystal diamond film, and removal of a surface layer by electrochemical etching, according to the same process as described above. The surface morphology of the single-crystal diamond substrate after the separation was evaluated using an atomic force microscope (AFM); as a result, the average surface roughness (Ra) was about 2 nm even after the repeated separation, and no change was observed.

The surface layer that had been separated from the single-crystal diamond substrate by the above-described process contained a surface layer of a single-crystal diamond substrate, and a single-crystal diamond film formed by a CVD method on the surface of the substrate. Two surface layers each containing the diamond growth layer, which had been separated in the above-described first and second procedures, were evaluated in terms of the crystallinity of the grown diamond film, using polarized light microscope images. The results confirmed that, as compared with the diamond growth film obtained after the first procedure, the diamond growth film obtained after the second procedure exhibited a significantly reduced number of dislocations. This result shows that, by the first removal procedure of the surface layer, the damaged portion present at the surface of the single-crystal diamond substrate was significantly removed.

### EXAMPLE 2

On an Ib diamond (100) substrate with a size of about 6 x 6 mm synthesized by a high-temperature high-pressure synthesis method, a CVD diamond was grown to a thickness of 8.7 mm by a microwave plasma CVD method. The resulting crystal was cut along the {100} plane in parallel with the growth direction to separate a portion of the crystal, and the surface of the separated crystal was polished to prepare a single-crystal diamond substrate in the form of a 7×8.5×1 mm³ trapezoid. This substrate was observed by transmission X-ray topography to confirm the inclusion of many dislocations toward a direction substantially in parallel with the growth direction.

According to the same process as in Example 1, the {100} surface of the single-crystal diamond substrate in parallel with the growth direction was subjected to the implantation of carbon ions and heat treatment, growth of a single-crystal diamond film for surface damage evaluation, and removal of a surface layer by electrochemical etching. This procedure was repeated four times. As a result of these procedures, a surface layer of about 1.6 μm was removed in each procedure. The separated four surface layers contained a diamond growth film with a thickness of about 200 μm. Because the growth conditions were identical, the crystallinity of each diamond growth film represents the degree of the surface damage of the substrate after the surface layer had been removed zero, one, two, or three times.

The crystallinity of the diamond growth film formed on each of the separated surface layers was evaluated based on the polarized light microscope images and the full width at half maximum (FWHM) of a high-resolution X-ray diffraction rocking curve using a Ge (440) four-crystal monochromator.

The polarized light microscope images of the diamond growth films showed that the number of dislocations decreased as the number of the above-described procedures increased, and became fixed after the surface layer had been removed two or more times.

Table 1 below shows the FWHM obtained by the high-resolution X-ray diffraction rocking curve measurements. The same trend as in the evaluation based on the microscope images was also observed for the FWHM of X-ray diffraction rocking curves, and ultimately, a very good result, i.e., 10 seconds or less, was obtained.

TABLE 1

| Number of | |
|---|---|
| Removals of | FWHM of X-Ray Rocking Curve |
| Surface Layers | (arcsec) |
| Substrate | 27 |
| 0 | 14 |
| 1 | 38 |
| 2 | 10 |
| 3 | 9.3 |

The above-mentioned results confirmed that the damage present in the surface portion of a single-crystal diamond can be substantially completely removed by repeating, according to the process of the invention, the formation of a non-diamond layer by ion implantation and the graphitization, and the removal of the resulting non-diamond layer by etching.

1. A process for removing surface damage of a single-crystal diamond, comprising implanting ions into a single-crystal diamond to form a non-diamond layer near a surface of the diamond, graphitizing the non-diamond layer, and removing a surface layer by etching.

2. A process for removing surface damage of a single-crystal diamond, comprising repeating, at least two times, the process of claim 1 comprising implanting ions into a single-crystal diamond to form a non-diamond layer near a surface of the diamond, graphitizing the non-diamond layer, and removing a surface layer by etching.

3. The process according to claim 1, wherein the single-crystal diamond to be processed is a single-crystal diamond synthesized by a CVD method, the single-crystal diamond having a surface substantially in parallel with a direction of propagation of dislocations in the diamond.

4. The process according to claim 2, wherein the single-crystal diamond to be processed is a single-crystal diamond synthesized by a CVD method, the single-crystal diamond having a surface substantially in parallel with a direction of propagation of dislocations in the diamond.

5. A process for producing a single-crystal diamond, comprising removing surface damage of a single-crystal diamond according to the process of claim 1; and growing a single-crystal diamond by a CVD method on a substrate of the single-crystal diamond from which the surface damage has been removed.

6. A process for producing a single crystal diamond, comprising removing surface damage of a single-crystal diamond according to the process of claim 2; and growing a single-crystal diamond by a CVD method on a substrate of the single-crystal diamond from which the surface damage has been removed.
